(19) United States
(12) Patent Application Publication
(10) Pub. No.: US 2020/0123480 A1
(43) Pub. Date: Apr. 23, 2020

(54) Process of Imparting Hop Flavours to a Beverage, A Hop Flavoured Beverage Component Obtainable By Such Process and Use Thereof

(71) Applicant: Anheuser-Busch InBev S.A., Brussels (BE)

(72) Inventors: Maria Del Carmen BARRERO PEREZ, Brussels (BE); Jacques-Gabriel GROS, Brussels (BE)

(21) Appl. No.: 16/620,798

(22) PCT Filed: Jun. 6, 2018
(86) PCT No.: PCT/EP2018/064845

§ 371 Date: Dec. 9, 2019

(30) Foreign Application Priority Data
Jun. 8, 2017 (BE) BE2017/5407
Jun. 8, 2017 (EP) 17175020.1

(51) Int. Cl. C12C 3/08; C12C 5/02; C12C 12/04; C12G 3/08

(52) U.S. Cl. CPC C12C 3/08; C12G 3/08; C12C 12/04; C12C 5/026

(57) ABSTRACT

A beverage component comprising: i. 2-96 w % of ethanol; ii. at least 0.1 ppm acetaldehyde, at least 1 ppm ethyl acetaldehyde, at least 60 ppm isoamyl alcohol and/or at least 0.1 ppm isoamyl acetate; and iii. Extracted hop flavour components including myrcene in an amount of at least 200 ppb and/or α-humulene in an amount of at least 800 ppb.

### FIELD OF THE INVENTION

The present invention concerns the production of malt-based beverages having a dry-hopped flavour profile, in particular to non-alcoholic or low-alcoholic beverages having such dry-hopped flavour profile.

### BACKGROUND TO THE INVENTION

Malt-based beverages having a dry-hopping profile are gaining market share and become of significant importance to many brewing companies. Dry-hopped beers and beer-like beverages are obtained by the addition of non-extracted hops (hop cones or hop pellets) or oils to the beer in a late stage of fermentation of even after fermentation, allowing the extraction of characteristic hop flavours components such as linalool, geraniol, myrcene and ahumulene in the beer.

It is known that the extraction is more efficient in the presence of ethanol than in non-alcoholic liquids. Hence when manufacturing a non-alcoholic beer or low-alcoholic beer, three different processes are applied to obtain a dry-hopping flavour profile. The first option, described in eg. ES 2214127 consists of dry-hopping the beer prior to de-alcoholisation. In this process the flavour components extracted from the hop are in large amounts lost during subsequent de-alcoholisation of the beer and a recovery of the lost compounds from the alcohol fraction is needed. Such recovery renders the process cumbersome, expensive in both equipment investment and operation cost and non-efficient. A second option, concerns the extraction of hops in the de-alcoholized beer, however due to the absence of alcohol or low concentration of alcohol such extraction only occurs at a very small yield, necessitating to provide large amounts of hops and rendering the process expensive and time consuming. A third known option is to mimic dry-hopping flavour profile by chemically adding exogenous components. The use of such additives is however far from desired due to labelling requirements, poor results in terms of flavour match and the need for purchasing expensive chemical food grade components.

Apart from the above processes to produce non-alcoholic or low-alcohol beer having a dry-hopping flavour profile, US2015/0064306 discloses a process of nested fermentation, wherein beer is partially de-alcoholized during fermentation to allow producing a high-alcoholic beer without inhibiting the fermentation process. In this US'306 hop pellets are added to the de-alcoholized fraction(s) for later entire re-addition to the fermented beer. This process however does not allow for the production of non-alcoholic or low-alcoholic beer with a dry-hopping flavour profile.

It follows there remains a need for producing non-alcoholic or low alcoholic beers having a dry-hopping profile in an efficient, industrially applicable and commercially acceptable manner.

### SUMMARY OF THE INVENTION

In order to meet the market need, the present invention concerns a process of preparing a beverage component comprising:
(a) preparing an alcohol containing liquid by fermentation of a malt-based wort;
(b) De-alcoholizing the alcohol containing liquid and collecting the dealcoholized fraction and an alcohol fraction comprising between 2 and 96 w % ethanol;
(c) Soaking an amount of hops in the alcohol fraction to extract hop components from the hops and obtain a beverage component comprising:
   i. 2-96 w % of ethanol;
   ii. at least 0.1 ppm acetaldehyde, at least 1 ppm ethyl acetaldehyde and/or at least 60 ppm isoamyl alcohol; and
   iii. extracted hop flavour components including myrcene in an amount of at least 200 ppb and/or α-humulene in an amount of 800 ppb.

The obtained beverage component hereby concerns a liquid solution that is very high in extracted hop flavour components and hence can be applied as a concentrate to be dosed in a non-alcoholic or low-alcoholic beverage base to obtain a desired dry-hopping flavour profile, yet without significant increase in alcohol level in the final beverage versus the non-alcoholic or low-alcoholic beverage base. In particular this process provides for an cost efficient and effective manner to produce non-alcoholic or low-alcoholic beverage having a dry-hopping flavour profile with the additional advantage that it allows for the recovery of some of the volatile flavour components lost during de-alcoholisation of the beverage base.

Unlike some of the existing processes to produce non-alcoholic beverages or low alcoholic beverages with a dry-hopping flavour profile, the process according to the invention does not necessitate the addition of chemical additives mimicking the dry-hopping flavour profile.

In an alternative embodiment, the alcohol fraction can be further concentrated in volatile flavour components originating from wort fermentation prior to soaking an amount of hops therein, allowing recovery of even more volatile flavour components lost during de-alcoholisation of the base liquid than without concentration step.

The amount of ethanol in the beverage component is preferably comprised between 2 and 85 w %, in particular between 2 and 60 w %.

The beverage component preferably comprises:
acetaldehyde in a concentration of between 0.1 and 20 ppm;
ethyl acetaldehyde in a concentration of between 1.5 and 250 ppm;
propanol in a concentration of between 10 and 50 ppm;
isobutanol in a concentration of between 8 and 100 ppm;
isoamyl acetate in a concentration of between 0 and 40 ppm;
isoamyl alcohol in a concentration of between 60 and 280 ppm;
ethyl hexanoate in a concentration of between 0 and 2 ppm;
ethyl octanoate in a concentration of between 0 and 2 ppm;
ethyl butyrate in a concentration of between 0 and 1 ppm;
ethyl decanoate in a concentration of between 0 and 0.020 ppm;
phenyl ethyl acetate in a concentration of between 0 and 2.5 ppm;
ethyl lactate in a concentration of between 0 and 0.35 ppm.

The present invention further also concerns the use of the above described beverage component, for addition to a fermented malt-based beverage base to obtain a mixed beverage with an ethanol concentration ranging between 0 and 6% ABV, preferably between 0 and 3.5% ABV, most preferably between 0 and 1.2% ABV. The beverage component is preferably mixed with a fermented malt-based beverage base in a ratio of between 1/1 to 1/20.

### BRIEF DESCRIPTION OF THE FIGURE

FIG. 1 schematically shows a process in accordance with the present invention.

### DETAILED DESCRIPTION OF A PREFERRED EMBODIMENT

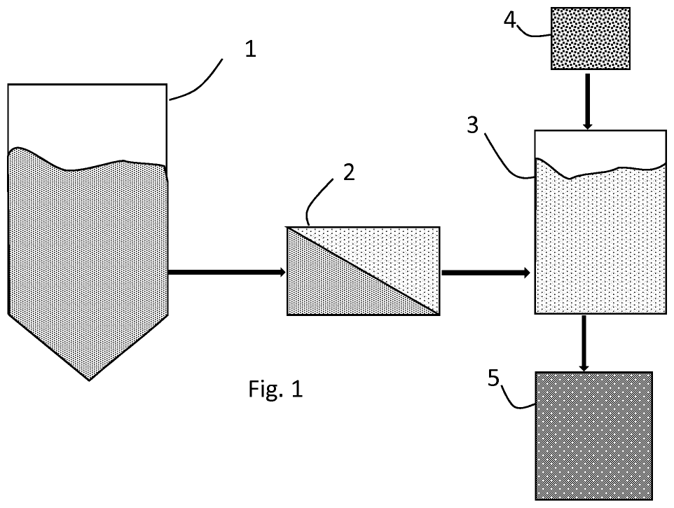

FIG. 1 shows a process in accordance with the present invention, wherein an alcohol containing liquid is prepared by fermentation in fermentation tank 1. The alcohol containing liquid is subsequently transferred to a de-alcoholisation unit 2 for removal of at least part of the alcohol, thereby obtaining a (partially) de-alcoholized liquid fraction and an alcohol fraction. According to the invention, the alcohol fraction is transferred to an hop extraction unit 3, wherein an amount of hops 4 is brought in contact with the alcohol fraction, allowing the extraction of hop flavours into the alcohol fraction obtaining a hop flavoured alcohol fraction 5.

The alcohol containing liquid preferably is a cereal-based, in particular malt-based fermented beverage such as beer (or a beer-like beverage). The beer can be produced from wort having a either a high fermentable sugar content that is allowed to ferment until full attenuation, producing a beverage with a relatively high alcohol content (more than 5% ABV) or can be obtained starting from a wort having a low amount of fermentable sugars that is allowed to ferment until full attenuation, producting a beverage with a relative low alcohol content (less than 5% ABV). Fermentation processes wherein fermentation is arrested prior to conversion of all fermentable sugars can also be applied.

As readily known in the art, the fermented beverage is subjected to a maturation process, removing yeast from the beverage and can subsequently be transferred to the de-alcoholisation unit 2. This unit can be of any type known in the art, including a distillation unit, an evaporation unit or a membrane based de-alcoholisation unit. In the de-alcoholisation unit, both a low-alcohol liquid fraction and an alcohol fraction are collected. The low-alcohol fraction preferably has a alcohol content of no more than 6% ABV and may even be totally alcohol free (0% ABV). Alternatively, the fermented beverage is de-alcoholized prior to filtration for yeast removal.

The alcohol fraction (alcohol in water mixture) preferably comprises between 2 and 96% ABV, preferably between 2 and 85% ABV, most preferably between 2 and 60% ABV, the concentration highly depending on the de-alcoholisation technique applied and on the composition of the fermented beverage used as starting liquid. Apart from ethanol, alcohol fraction comprises volatile flavour components originating from the starting liquid, these volatile flavours including at least 0.1 ppm acetaldehyde and/or at least 1 ppm ethyl acetaldehyde and/or at least 60 ppm isoamyl alcohol and/or at least 0.1 ppm isoamyl acetate.

Based on a set of experiments, the alcohol fraction obtained generally contains: acetaldehyde in a concentration of between 0.1 and 20 ppm; ethyl acetaldehyde in a concentration of between 1.5 and 250 ppm; propanol in a concentration of between 10 and 50 ppm; isobutanol in a concentration of between 8 and 100 ppm; isoamyl acetate in a concentration of between 0 and 40 ppm; isoamyl alcohol in a concentration of between 60 and 280 ppm; ethyl hexanoate in a concentration of between 0 and 2 ppm; ethyl octanoate in a concentration of between 0 and 2 ppm; ethyl butyrate in a concentration of between 0 and 1 ppm; ethyl decanoate in a concentration of between 0 and 0.020 ppm; phenyl ethyl acetate in a concentration of between 0 and 2.5 ppm; ethyl lactate in a concentration of between 0 and 0.35 ppm.

In a next process step, the alcohol fraction is transferred to an hop extraction unit 3, wherein hop material is brought in to contact with the alcohol fraction to extract flavour components or flavour precursors from the hop into the alcohol fraction. The alcohol fraction may be conditioned for the extraction of hop material by adjusting for example, one or more of acidity, temperature, alcohol level (dilution or further concentration of the alcohol), . . . . The hop material may concern hop cones or any other vegetative part of the hop plant, including hop leafs and hop rootlets or mixtures of several hop plant parts. For practical reasons, the hop material is preferably added in the form of pellets. For the extraction process step, it is preferred that an extraction tank is first purged with CO₂ or N₂ to remove oxygen, and subsequently filled with an amount of the alcohol fraction while maintaining overpressure (CO₂ or N₂ atmosphere) in the tank to prevent foaming. Once filled, the hop material is soaked into the liquid alcohol fraction and maintained in the liquid under gently stirring conditions allowing extraction of hop flavour components and/or flavour precursors into the alcohol fraction and as such to obtain a hop flavoured beverage component according to the present invention.

The amount of hops soaked in the alcohol fraction is chosen to obtain a beverage component comprising myrcene in an amount of at least 200 ppb and/or α-humulene at least 800 ppb. Preferably, the hop flavour components extracted from the hop material preferably include one or more of: linalool in a concentration of between 500 and 2000 ppb; geraniol in a concentration between 500 and 2000 ppb; myrcene in a concentration of between 200 and 2000 ppb; humulene in a concentration of between 800 and 4000 ppb.

Clearly such concentration of hop flavours are beyond the concentrations found in ready to drink beers and will allow dosing a (small) amount of the obtained beverage component in a fermented malt-based beverage base as flavourant, preferably in a ratio of 1/1 to 1/20 beverage component/base. Such use of the beverage component according to the present invention is particularly desired for non-alcoholic or low-alcoholic beverage bases, which as such can be imparted with hoppy notes, without important impact on the alcohol concentration of the final beverage that can be remained at an ethanol concentration ranging between 0 and 6% ABV, preferably between 0 and 3.5% ABV, most preferably between 0 and 1.2% ABV.

According to a preferred embodiment, the beverage component is used to impart hop flavours (comparible to dry hop flavours) to the de-alcoholized liquid fraction obtained in the same process or starting from the same starting liquid. In other words, the de-alcoholized beverage base preferably originates from a single malt-based fermentation process, although this is not a prerequisite.

According to a preferred execution of the process, the step of soaking the hops in the alcohol fraction is performed in situ with the de-alcoholisation step of the process, thereby minimizing the time between de-alcoholisation and extraction to minimize loss of volatile beer flavour components. Alternatively, the beverage component according to the present invention can be stored, further concentrated and/or shipped for use elsewhere, either in a brewery/bottling plant or at a point of consumption.

Optionally, one could consider adding some brewer's yeast to the mixture of beverage base and beverage component, in conditions allowing the yeast to bioconvert some of the extracted hop flavour precursors into volatile hop flavour components.

It is clear that the process of the present invention is in se not only applicable for producing a beverage component having hop based flavours, but can be applied for any type of flavour source from which flavour components can be extracted in alcohol, including, botanicals such as hyssopus, tea leaves, jasmine flowers, guarana, hop vine leaves, etc.; fruits (including dried fruits) such as cherry, orange, etc. or other plants or plant parts.

1. A beverage component comprising:
i. 2-96 w % of ethanol;
ii. at least 0.1 ppm acetaldehyde, at least 1 ppm ethyl acetaldehyde, at least 60 ppm isoamyl alcohol and/or at least 0.1 ppm isoamyl acetate; and
iii. Extracted hop flavour components including myrcene in an amount of at least 200 ppb and/or α-humulene in an amount of at least 800 ppb.

2. The beverage component according to claim 1, the amount of ethanol comprised between 2 and 85 w %.

3. The beverage component according to claim 1, comprising one or more components chosen from:
acetaldehyde in a concentration of between 0.1 and 20 ppm;
ethyl acetaldehyde in a concentration of between 1.5 and 250 ppm;
propanol in a concentration of between 10 and 50 ppm;
isobutanol in a concentration of between 8 and 100 ppm;
isoamyl acetate in a concentration of between 0 and 40 ppm;
isoamyl alcohol in a concentration of between 60 and 280 ppm;
ethyl hexanoate in a concentration of between 0 and 2 ppm;
ethyl octanoate in a concentration of between 0 and 2 ppm;
ethyl butyrate in a concentration of between 0 and 1 ppm;
ethyl decanoate in a concentration of between 0 and 0.020 ppm;
phenyl ethyl acetate in a concentration of between 0 and 2.5 ppm; and
ethyl lactate in a concentration of between 0 and 0.35 ppm.

4. The beverage component according to claim 1, comprising one or more components chosen from:
linalool in a concentration of between 500 and 2000 ppb;
geraniol in a concentration between 500 and 2000 ppb;
myrcene in a concentration of between 200 and 2000 ppb; and
α-humulene in a concentration of between 800 and 4000 ppb.

5. The beverage component according to claim 1, the components identified in item ii) of claim 1 originating from a malt-based fermentation process.

6-8. (canceled)

9. Use of the beverage component of claim 1 for addition to a fermented malt-based beverage base to obtain a mixed beverage with an ethanol concentration ranging between 0 and 6% ABV.

10. The use of a beverage component according to claim 9, wherein the beverage component is added to the to a fermented malt-based and de-alcoholized beverage base.

11. The use according to claim 9, wherein the beverage component and the de-alcoholized beverage base originate from a single malt-based fermentation process.

12. The use according to claim 9, wherein the beverage component is mixed with a fermented malt-based beverage base in a ratio of between 1/1 to 1/20.

13. The beverage component according to claim 2, the amount of ethanol comprised between 2 and 60 w %.

14. The use of a beverage component according to claim 9, wherein the ethanol concentration is between 0 and 3.5% ABV.

15. The use of a beverage component according to claim 14, wherein the ethanol concentration is between 0 and 1.2% ABV.

16. The beverage component according to claim 1, comprising one or more components chosen from:
acetaldehyde;
ethyl acetaldehyde;
propanol;
isobutanol;
isoamyl acetate;
isoamyl alcohol;
ethyl hexanoate;
ethyl octanoate;
ethyl butyrate;
ethyl decanoate;
phenyl ethyl acetate; and
ethyl lactate.

17. The beverage component according to claim 1, comprising one or more components chosen from:
linalool;
geraniol;
myrcene; and
α-humulene.
